(19) United States
(12) Patent Application Publication
(10) Pub. No.: US 2014/0269763 A1
(43) Pub. Date: Sep. 18, 2014

(54) SWITCHING A NETWORK CONNECTION FROM A FIRST NETWORK PROTOCOL TO A SECOND NETWORK PROTOCOL

(71) Applicant: QUALCOMM INCORPORATED, San Diego, CA (US)

(72) Inventors: Alexander Gantman, Yokneam (IL); Yossef Tsfati, Rishon-Le-Zion (IL)

(73) Assignee: QUALCOMM Incorporated, San Diego, CA (US)

(21) Appl. No.: 13/838,370

(22) Filed: Mar. 15, 2013

(51) Int. Cl. H04L 29/06

(52) U.S. Cl. CPC H04L 69/08; H04L 65/1069; H04L 65/1083
USPC 370/467

(57) ABSTRACT

Systems and methods for switching between communicating according to a first network protocol and a second network protocol are provided. The provided systems and methods multiplex received communications according to the first and second network protocols and select one of the network protocols based on a quality or throughput of the network protocol without terminating any existing sessions established according to either of the first or second network protocols.

### TECHNICAL FIELD

Embodiments disclosed herein are generally directed to network communications and the switching or hand-off of communications according to a first network protocol to a second network protocol. In particular, embodiments disclosed herein are directed to switching from communicating according to a first network protocol to communicating according to a second network protocol without terminating any existing sessions according to the first network protocol.

### BACKGROUND

With the increase of portable computing devices, it is desirable for networks, both wired and wireless, to be faster, more reliable, and wider ranged. In an attempt to increase speed, reliability, and range, different network protocols have developed to address one or more of these desired factors. However, each protocol has certain limitations and advantages. For example, a wired network has a very limited range (limited to the length of the Ethernet cable), but provides a very stable and fast connection. As another example, the IEEE 802.11n wireless network protocol provides a good range, but has a limited throughput of only about 54 Mbit/s to 600 Mbit/s. The IEEE 802.11ac wireless network protocol enables multi-station wireless area networks to have throughput of about 1 Gbit/s, but only provides a maximum single link throughput of about 500 Mbit/s. The IEEE 802.11ad wireless network protocol (WiGig™), on the other hand has a maximum throughput of about 7 Gbit/s, but has a very limited range.

Ideally, a network would be constructed to provide continuous coverage at the fastest possible throughput. For example, a network constructed to provide continuous coverage of the about 7 Gbit/s offered by the IEEE 802.11ad wireless network protocol would provide the fastest possible throughput. However, due to the limited range of the IEEE 802.11ad wireless network protocol, a large number of IEEE 802.11ad-capable network station would be required to provide continuous coverage, and would be impractical due to the cost of implementing such a large number of IEEE 802.11ad-capable network stations. As a result, networks are likely to be constructed with a mix of network protocols to maximize coverage and throughput. For example, a network may include IEEE 802.11n-capable network stations to provide maximum coverage, along with IEEE 802.11ad-capable network stations to cover certain areas of the network and provide additional throughput in those certain areas. The network may even have wired, Ethernet-capable network stations to provide wired network coverage. Due to the different network protocols used to construct a network that attempts to maximize coverage and throughput, a user may encounter more than one network protocol as the user moves with his/her portable computing device.

While some functionalities exist for handing off communications from one network protocol to another, the hand off typically involves termination of existing sessions. In situations where the user is streaming media, performing a large file transfer, or performing a backup to the cloud, termination of the existing sessions will result in the user needing to re-establish the sessions.

What is needed are systems and methods for switching a network connection from a first network protocol to a second network protocol without terminating an existing session.

### SUMMARY

Consistent with some embodiments, there is provided a method of switching a point-to-point network connection from a first network protocol to a second network protocol. The method includes receiving a first communication according to the first network protocol, establishing a connection to receive a second communication according to the second network protocol, receiving the second communication, and multiplexing the received first and second communications. The multiplexing the received first and second communications includes analyzing the received first and second communications, and selectively providing the received first and second communications to a protocol stack based on the analysis.

Consistent with some embodiments, there is also provided a method of transmitting and receiving communications according to at least a first network protocol and a second network protocol. The method includes establishing a first connection to a network station to communicate according to the first network protocol, coupling a multiplexer driver between an internet protocol (IP) stack and drivers enabling communications according to the first network protocol and the second network protocol, receiving a first communication according to the first network protocol, providing the received first communication to the IP stack, establishing a second connection to the network station to communicate according to the second network protocol, receiving a second communication according to the second network protocol, multiplexing the received first and second communications, and providing the received second communication to the IP stack if the second network protocol provides at least one capability that is an improvement over the first network protocol.

Consistent with some embodiments, there is further provided a communications system. The communications system includes a first network station capable of communications over at least a first network protocol and a second network protocol. The first network station includes at least one processor, a protocol stack for facilitating the communications, a first network device for communicating according to the first network protocol, a second network device for communicating according to the second network protocol, and a multiplexer coupled between the first network device and the second network device and the protocol stack. The multiplexer is configured to: receive and transmit communications according to the first network protocol from and to the first network device, receive and transmit communications according to the second network protocol from and to the second network device, and receive and transmit communications according to a selected one of the first and second network protocols from and to the protocol stack.

### BRIEF DESCRIPTION OF THE DRAWINGS

FIG. 1 is a diagram illustrating a networked system, consistent with some embodiments.

FIG. 2 is a diagram illustrating a network station, consistent with some embodiments.

FIGS. 3A and 3B are diagrams illustrating a first network station in communication with a second network station, consistent with some embodiments.

FIGS. 4A and 4B are diagrams illustrating a first network station in communication with a second network station, according to some embodiments.

FIGS. 5A and 5B are diagrams illustrating communications between three network stations, according to some embodiments.

FIG. 6 is an example of a communication system, consistent with some embodiments.

FIG. 7 is a flowchart illustrating a method of switching from communicating according to a first network protocol to communicating according to a second network protocol, consistent with some embodiments.

FIG. 8 is a flowchart illustrating a method of communicating according to a first network protocol or a second network protocol, consistent with some embodiments.

In the drawings, elements having the same designation have the same or similar functions.

### DETAILED DESCRIPTION

In the following description specific details are set forth describing certain embodiments. It will be apparent, however, to one skilled in the art that the disclosed embodiments may be practiced without some or all of these specific details. The specific embodiments presented are meant to be illustrative, but not limiting. One skilled in the art may realize other material that, although not specifically described herein, is within the scope and spirit of this disclosure.

FIG. 1 is a diagram illustrating a networked system, consistent with some embodiments. As shown in FIG. 1, a first station 102 may communicate and exchange information with a second station 104 via network 106 or via a direct coupling 108. Information, as used herein, may refer to data or data packets that are transmitted between first station 102 and second station 104. Although only first station 102 and second station 104 are shown, system 100 may have more stations.

Network 106, in one embodiment, may be implemented as a single network or a combination of multiple networks. For example, in various embodiments, network 106 may include the Internet and/or one or more intranets, landline networks, wireless networks, and/or other appropriate types of communication networks. In another example, the network may comprise a wireless telecommunications network (e.g., cellular phone network) adapted to communicate with other communication networks, such as the Internet. Similarly, direct coupling 108 may be a wired coupling or a wireless coupling. A wired coupling or wired network may be an Ethernet network, a powerline communication network, or other suitable wired network. A wireless coupling or wireless network may be a WLAN network that adheres to one or more Institute of Electrical and Electronic Engineers (IEEE) standards, such as IEEE 802.11a, b, g, n, ac, or ad. The wireless coupling or wireless network may also be a network that adheres to other standards such as Bluetooth®, WiMAX, ZigBee®, etc.

First station 102 and second station 104 may each be an electronic device configured to implement one or more communication protocols or access technologies, such as a mobile phone, a smartphone, a tablet computer, a smart appliance, a set-top box (STB), a gaming console, a desktop computer, a laptop computer, a notebook computer, or other suitable electronic devices. First station 102 and second station 104 may also be network devices, such as a network router, a home gateway, a WLAN access point, or a network switch. First station 102 and second station 104 may be implemented using any appropriate combination of hardware and/or software configured for wired and/or wireless communication over network 106 and/or over direct coupling 108. For example, first station 102 and second station 104 may each comprise one or more processors and capable of reading instructions stored on a non-transitory machine-readable medium for execution by the one or more processors. Some common forms of machine-readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which one or more processors or computer is adapted to read.

FIG. 2 is a diagram illustrating network station 200, which may correspond to any of first station 102 or second station 104 shown in FIG. 1, consistent with some embodiments. Network station 200 may include an optional Ethernet component 202 configured for wired communication with a network such as network 106 shown in FIG. 1 or direct communication with another network station. Consistent with other embodiments, Ethernet component 202 may be configured to interface with a coaxial cable, a fiber optic cable, a digital subscriber line (DSL) modem, a public switched telephone network (PSTN) modem, an Ethernet device, and/or various other types of wired network communication devices.

Consistent with some embodiments, network station 200 includes a system bus 204 for interconnecting various components within network station 200 and communicating information between the various components. Such components include a processing component 206, which may be one or more processors, micro-controllers, or digital signal processors (DSP), a system memory component 208, which may correspond to random access memory (RAM), an internal memory component 210, which may correspond to read only memory (ROM), and an external or static memory 212, which may correspond to optical, magnetic, or solid-state memories. Consistent with some embodiments, network station 200 may optionally include a display component 214 for displaying information to a user. Display component 214 may be a liquid crystal display (LCD) screen, an organic light emitting diode (OLED) screen (including active matrix AMOLED screens), an LED screen, a plasma display, or a cathode ray tube (CRT) display. Network station 200 may also include an optional input and navigation control component 216, allowing for a user to input information and navigate along display component 214. An input and navigation control component 216 may include, for example, a keyboard or key pad, whether physical or virtual, a mouse, a trackball, or other such device, or a capacitive sensor based touch screen.

Network station 200 may also include one or more wireless transceivers, such as first wireless transceiver 218-1 and second wireless transceiver 218-2. Network station 200 may include N wireless transceivers 218-N, wherein each wireless transceiver may include an antenna that is separable or integral and is capable of transmitting and receiving information according to a different wireless network protocol, such as Wi-Fi™, 3G, 4G, HDSPA, LTE, RF, NFC, IEEE 802.11a, b, g, n, ac, or ad, Bluetooth®, WiMAX, ZigBee®, etc. According to some embodiments, first wireless transceiver 218-1 may transmit and receive information according to the IEEE 802.11n wireless network protocol, and second wireless transceiver 218-2 may transmit and receive information according to the IEEE 802.11ad wireless network protocol. According to some embodiments, N wireless transceivers 218-N may be implemented using the same hardware but with different drivers for each wireless network protocol. The drivers may be stored in any of memory 208, 210, or 212 and be executed by one or more processors of processing component 206.

As noted previously, network station 200 may be configured for transmitting and receiving information over a network 106 or directly to another coupled network station using any of Ethernet component 202 or first wireless transceiver 218-1-Nth wireless transceiver 218-N. When network station 200 establishes a network connection using one network protocol, whether a wired network protocol such as Ethernet using Ethernet component 202 or a wireless network protocol such as IEEE 802.11n, 802.11ac, or 802.11ad using wireless transceivers 218-1 through 218-N, uninterrupted connection during the session is important, especially if network station 200 is a mobile device. However, because of the difficulties in constructing a network that maximizes coverage and throughput referred to previously, network station may be required to transition or switch between different wireless network protocols to achieve continuous coverage and maximum throughput. To achieve minimal interruption due to the transition or switching from one protocol to a different protocol, the IEEE 802.11 standard specifies the Fast Session Transfer (FST) mechanism which begins establishing a connection according to a different wireless network protocol while maintaining the connection with a first wireless network protocol. The connection is then handed off from the first network wireless protocol to the second wireless protocol. The connections according to the first wireless network protocol and the second wireless network protocol may be established by different wireless transceivers 218-1 through 218-N. For example, the connection according to the first wireless network protocol may be established by first wireless transceiver 218-1, while the second connection according to the second wireless network protocol may be established by the second wireless transceiver 218-2.

In some embodiments, wireless transceivers 218-1 through 218-N may have a same internet protocol (IP) address but different media access controller (MAC) addresses. For example, first wireless transceiver 218-1 may have a first MAC address, and second wireless transceiver 218-2 may have a second MAC address. However, network stations, such as network station 200, may be able to connect to one MAC address for each IP address at a time due to operating system limitations in handling communications in the protocol stack. As a result, after the connection has been established with the second wireless transceiver 218-2 using the second wireless network protocol, the hand off to the second wireless network protocol involves the termination of the connection according to the first wireless network protocol before the connection according to the second wireless network protocol can be active. In situations where the user is streaming media, backing up files to the cloud, or performing a large file transfer, the termination of the existing connection according to the first wireless protocol will result in the need to restart the task that may be partially complete. This problem is illustrated further in FIGS. 3A and 3B.

FIGS. 3A and 3B are diagrams illustrating a first network station in communication with a second network station, consistent with some embodiments. First network station 302 and second network station 304 may correspond to network station 200 shown in FIG. 2. Moreover, first network station 302 may correspond to first station 102 in FIG. 1, and second network station 304 may correspond to second station 104 in FIG. 1. As shown in FIG. 3A, first network station 302 may include a first network device 306 and a second network device 308. Consistent with some embodiments, first network device 306 may be configured to enable first network device 302 to transmit and receive information according to a first network protocol. Second network device 308 may be configured to enable first network station 302 to transmit and receive information according to a second network protocol. According to some embodiments, first network device 306 and second network device 308 may correspond to any of first to Nth wireless transceivers 218-1 to 218-N, shown in FIG. 2. According to other embodiments, first network device 306 and second network device 308 may correspond to a first and second driver that enables the transmission and reception of information according to a first and second network protocol, respectively. In some embodiments, first network device 306 and second network device 308 may have different MAC addresses. At least one of first network device 306 and second network device 308 may be coupled to internet protocol (IP) stack 310. However, as noted previously, IP stack 310 may support one connection from one MAC address at a time, such that one of first network device 306 and second network device 308 may be coupled to IP stack 310 at a time.

Second network station 304 may be configured similarly as first network station 302. Second network station 304 may include a first network device 312 and a second network device 314. Consistent with some embodiments, first network device 312 may be configured to enable second network station 304 to transmit and receive information according to a first network protocol. Second network device 314 may be configured to enable second network station 304 to transmit and receive information according to a second network protocol. In some embodiments, the first network protocol enabled by first network device 312 and the second network protocol enabled by second network device 314 are the same first and second network protocols enabled by first device 306 and second device 308, respectively. According to some embodiments, first network device 312 and second network device 314 may correspond to any of first to Nth wireless transceivers 218-1 to 218-N, shown in FIG. 2. According to other embodiments, first network device 312 and second network device 314 may correspond to a first and second driver that enable the transmission and reception of information according to a first and second network protocol, respectively. In some embodiments, first network device 312 and second network device 314 have different MAC addresses. At least one of first network device 312 and second network device 314 may be coupled to internet protocol (IP) stack 316. IP stack 316 may support one connection from one MAC address at a time, such that one of first network device 312 and second network device 314 may be coupled to IP stack 316 at a time.

As shown in FIG. 3A, first network station 302 is in communication with second network station 304 over a first network protocol enabled by first network device 306 of first network station 302 and first network device 312 of second network station 304. The information transmitted and received by first network device 306 of first network station 302 and first network device 312 of second network station 304 are passed to IP stack 310 of first network station 302 and IP stack 316 of second network station 304. Consistent with some embodiments, communications provided by second network devices 308 and 314 may be faster, more secure, or more reliable, when available. When such communications are available, it may be desirable to switch to communications provided by second network devices 308 and 314. As shown in FIG. 3B, if second network device 308 of first network station 302 establishes communication with second network device 314 of second network station 304, a first multiplexer driver 318 is enabled and coupled between IP stack 310 of first network station 302 and first network device 306 and second network device 308 of first network station 302, and a second multiplexer driver 320 is enabled and coupled between IP stack 316 of second network station 304 and first network device 312 and second network device 314 of second network station 304. Consistent with some embodiments, first and second multiplexer drivers 318 and 320 may be enabled and coupled between the network devices and the IP stacks by an operating system of first network station 302 and second network station 304 to handle the simultaneous communications from first devices 306 and 312 according to the first network protocol and second devices 308 and 314 according to the second network protocol. First and second multiplexer drivers 318 and 320 may provide multiplexing and demultiplexing functions between the IP stacks and network devices of the network stations. Multiplexer drivers 318 and 320 may select information from either of the first network device or the second network device to pass to the IP stack, and may selectively provide information from the IP stack to the first network device or the second network device.

At the same time that the multiplexer drivers 318 and 320 are enabled in first network station 302 and second network station 304, the communication between first network device 306 of first network station 302 and first network device 312 of second network station 304 is terminated because the network stations cannot enable a multiplexer driver on top of an existing connection due to limitations in the operating system of the network stations. As a result, any information that was being transmitted between first network station 302 and second network station 304 enabled by first network device 306 and second network device 308 will be lost. For instances when a large file transfer or backup was being performed between first network station 302 and second network station 304, the progress may be lost resulting in the need to begin the file transfer or backup again.

FIGS. 4A and 4B are diagrams illustrating a first network station in communication with a second network station, according to some embodiments. The network stations 302 and 304 in FIG. 4A include multiplexer drivers 402 and 404 that coupled between the network devices and IP stacks even when communication between first network station 302 and second network station 304 is only through first network device 306 of first network station 302 and first network device 312 of second network station 304. Consistent with some embodiments, multiplexer drivers 402 and 404 may be enabled and coupled between IP stacks 310 and 316 and network devices 306, 308, 312, and 314 by an operating system of first network station 302 and second network station 304 upon establishing a connection. According to some embodiments, multiplexer drivers 402 and 404 may be enabled and coupled between the IP stacks and the network devices upon establishing a connection with a network station that supports Fast Session Transfer (FST). Referring to first network station 302, multiplexer driver 402 selectively provides information from first network device 306 and second network device 308 to IP stack 310. Similarly, multiplexer driver 404 of second network station 304 selectively provides information from first network device 312 and second network device 314 to IP stack 316.

Consistent with some embodiments, multiplexer driver 402 includes logic that analyzes the communications from first network device 306 and second network device 308 to determine whether to select the communications from the first network device 306 or the second network device 308. The logic may analyze the communications to select the faster communication or the more stable communication. According to some embodiments, the logic may be able to determine a quality of the communications or a capability of the other station that it is in communication with. As shown in FIG. 4A, communication is established between first station 302 and second station 304 using first network device 306 in first station 302 and first network device 312 in second station 304. Multiplexer driver 402 may select the communications from first network device 306 because it is the only communications received by multiplexer driver 402, and provides the communications to IP stack 310. Communications received from IP stack 310 may then be selectively provided to first network device 306.

Similarly, multiplexer driver 404 includes logic that analyzes the communications from first network device 312 and second network device 314 to determine whether to select the communications from the first network device 312 or second network device 314. As shown in FIG. 4A, multiplexer driver 404 selects the communications from first network device 312 because it is the only communications received by multiplexer driver 404, and provides the communications to IP stack 316. Communications received from IP stack 316 may then be selectively provided to first network device 312.

As shown in FIG. 4B, when a connection is established between first network station 302 and second network station 304 using second network devices 308 and 314, communications from first network devices 306 and 312 and second network devices 308 and 314 are respectively provided to multiplexer drivers 402 and 404. Multiplexer driver 402, for example, may then analyze the communications from first network device 306 and second network device 308 and determine which device is providing communications that have at least one improved capability. Based on this analysis, multiplexer driver 402 may select communications from one of first and second network devices 306 and 308 to provide to IP stack 310 and to which of first and second network devices 306 and 308 to provide communications from IP stack 310. Multiplexer driver 404 may perform a similar analysis to make a selection.

Consistent with some embodiments, multiplexer driver 402 and multiplexer driver 404 may select communications having a same communications protocol. That is, if first network device 306 of first network station 302 transmits and receives communications according to a first network protocol and second network device 314 of second network station 304 transmits and receives communications according to a second communications protocol, multiplexer driver 402 may not select communications from first network device 306 while multiplexer driver 404 selects communications from second network device 314, and vice versa. In some embodiments, the selection made by the multiplexer drivers may be made based on the available communication protocols, and their respective capabilities. For example, if second network devices 308 and 314 enable communications according to the IEEE 802.11ad standard, and communication between first network station 302 and second network station 304 may be enabled by second network devices 308 and 314, multiplexer drivers 402 and 404 may select communications from second network device 308 and 314 due to the speed provided by the protocol those devices enable. The switch from communications enabled by first network device 306 and 312 to communications enabled by second network devices 308 and 314 may be a session handoff according to the FST specification.

Returning to FIG. 4B, communications between first network station 302 and second network station 304 enabled by first network device 306 and second network device 308 may not be terminated when communications between first network station 302 and second network station 304 enabled by second network devices 308 and 314 are available and second network device 308 of first network station 302 connects to second network device 314 of second network station 304. Instead, communications from both first network device 302 and second network device 304 may be transmitted to the multiplexer driver 402 and 404, which then may select a single communication stream to send to the IP stack 310 and 316. As a result, a user may not have to restart an online backup or a file transfer again if the communications between the first network station 302 and second network station 304 switch from a first protocol enabled by the first network devices 306 and 312 to a second protocol enabled by the second network devices 308 and 314.

FIGS. 5A and 5B are diagrams illustrating communications between three network stations, according to some embodiments. As shown in FIG. 5A, first network station 302 is in communication with second network station 304 enabled by first network devices 306 and 312. At the same time, first network station 302 is also in communication with third network station 502 enabled by second network devices 308 and 504. In order to accommodate the communications with third network station 502, an operating system of first network station 302 has enabled an additional multiplexer driver 506 and an additional IP stack 508 for communicating with the different IP and MAC address of third network station. Third network station 502 also includes a network device 504 that may be configured to communicate with second network device 308 of first network station 302. That is, network device 504 may enable communications according to the same network protocol as second network device 308. Although not shown, third network station 502 may include a multiplexer driver that selectively transmits communications between one or more network devices, including network device 504, to IP stack 510.

As shown in FIG. 5A, since first network station 302 is communicating with two network stations having different IP addresses, two IP stacks 310 and 508 may be active in first network device 302, with separate multiplexer drivers 402 and 506 between the IP stacks 310 and 508 and the network devices 306 and 308. Multiplexer drivers 402 and 506 in first network station 302 may selectively transmit communications from first network device 306 and second network device 308, respectively, while still allowing for multiple connections to be made to first network station 302. Moreover, multiplexer drivers 402 and 506 may allow for multiple connections to be made to first network station by a single network station having a single IP and MAC address, as shown in FIG. 5B.

As shown in FIG. 5B, first network station 302 establishes a second connection to second network station 304 enabled by second network devices 308 and 314. In some embodiments, a network device may maintain one connection at a time, and the connection to third network station 502 enabled by second network device 308 is terminated. The communications between first network station 302 and second network station 304 enabled by first network devices 306 and 312 and second network devices 308 and 314 may be selectively transmitted to IP stacks 310 and 316 by multiplexer drivers 402 and 404. Moreover, since multiplexer drivers 402 and 404 may receive communications from first network devices 306 and 312 and second network devices 308 and 314, the connection between first network station 302 and second network station 304 enabled by first network devices 306 and 312 may not be terminated.

FIG. 6 is an example of a communication system, consistent with some embodiments. As shown in FIG. 6, a user 602 having a laptop computer 604 may be coupled to a wireless access point 606 via a first communications protocol 608 having a coverage designated by dashed lines. Wireless access point 606 may also be capable of communicating using a second communications protocol 610 having coverage designated by solid lines. As shown, second communications protocol 610 may have a smaller coverage than first communications protocol 608. However, second communications protocol 610 may have other capabilities that may be improved over first communications protocol 608, such as greater bandwidth, more stability, faster throughput, etc. In a particular embodiment, first communications protocol 608 may correspond to the IEEE 802.11n wireless protocol, and second communications protocol 610 may correspond to the IEEE 802.11ad protocol.

As user 602 moves from either area 612 covered by first communications protocol 608 into area 614 covered by both first communications protocol 608 and second communications protocol 610 coverage, it may be desirable to switch from first communications protocol 608 to second communications protocol 610 due to improved capabilities provided by second communications protocol 610, such as increased throughput and bandwidth. However, if user 602 is currently performing a large file transfer or streaming media, user 602 may not want the file transfer or streaming media to be terminated as the communications are handed off from the first communications protocol 608 to the second communications protocol.

Referring back to FIGS. 4A and 4B, laptop computer 604 may correspond to first network station 302 and wireless access point 606 may correspond to second network station 304. Moreover, communications according to the first network protocol 608 may be enabled by first network devices 306 and 312 and communications according to the second network protocol 610 may be enabled by second network devices 308 and 314. Further, laptop computer 604 and wireless access point 606 may include multiplexer drivers 402 and 404, respectively. Consequently, when user 602 with laptop computer 604 moves from area 612 into area 614, communications according to the first network protocol 610 may be handed off to communications according to the second network protocol 612 without terminating the communications according to the first protocol 610.

FIG. 7 is a flowchart illustrating a method of switching from communicating according to a first network protocol to communicating according to a second network protocol, consistent with some embodiments. For the purpose of illustration, FIG. 7 will be described with reference to FIGS. 2, 4A and 4B. The method shown in FIG. 7 may be embodied in computer-readable instructions for execution by one or more processors in processing component 206 of a network station, such as first network station 302 and/or second network station 304. As shown in FIG. 7, a network station may receive a first communication according to a first network protocol (702). Consistent with some embodiments, the network station may correspond to first network station 302 or second network station 304. The first communication received according to a first network protocol may be enabled by a first network device 306 or 312, which may correspond to a driver for the first network protocol. A connection may then be established with the same device to receive a second communication according to a second network protocol (704). The second communication according to the second network protocol may be enabled by second network device 308 or 314, which may correspond to a driver for the second network protocol. The network station may then begin to receive the second communication according to the second network protocol (706). The first and second communications may then be provided to a multiplexer driver enabled in the network station (708). The multiplexer driver may correspond to multiplexer drivers 402 and/or 404 coupled between network devices and an IP stack 310 or 316 of network stations 302 and 304. The multiplexer driver may then use logic to analyze the first and second communications (710), and selectively provide the first or second communications to the protocol stack of the network station based on the analysis (712). According to some embodiments, the logic used to analyze the first and second communications may include logic to analyze capabilities of the communications according to the first and second network protocols including at least one of a speed, throughput, bandwidth, signal strength, and reliability of the first and second communications to determine if at least one capability is improved in one network protocol over the other network protocol. Moreover, the protocol stack may be an IP stack 310 and 316. Further, the selected communications may be provided to the protocol stack without terminating the connection with the not selected communications. That is, if the second communication is selected, the second communication may be provided to the protocol stack without terminating the connection for receiving the first communication. Similarly, the protocol stack may then provide information back to the multiplexer driver, which may then be transmitted according to the selected communications protocol by the network device that enables communication according to the selected communications protocol.

FIG. 8 is a flowchart illustrating a method of communicating according to a first network protocol or a second network protocol, consistent with some embodiments. For the purpose of illustration, FIG. 8 will be described with reference to FIGS. 1, 2, 4A and 4B. The method shown in FIG. 8 may be embodied in computer-readable instructions for execution by one or more processors in processing component 206 of a network station, such as first network station 302 and/or second network station 304. As shown in FIG. 8, the method begins when a first network station 302 establishes a connection with a second network station 304 according to a first network protocol (802). Consistent with some embodiments, a first communication according to the first network protocol may be enabled by a first network device 306 or 312, which may be a driver for a particular network protocol. A multiplexer driver 402 and 404 is then enabled and coupled between network devices in the stations 302 and 304 and a protocol stack 310 and 316 in the station (804). According to some embodiments, the multiplexer drivers 402 and 404 may be enabled if a determination is made that the connecting station 302 or 304 supports Fast Session Transfer (FST). After the multiplexer driver 402 and 404 has been enabled, network stations 302 and 304 may begin receiving a first communication according to the first network protocol enabled by first network devices 306 and 312 (806). The first communication may also be transmitted according to the first network protocol. According to some embodiments, the first network protocol may correspond to a wireless standard, such as IEEE 802.11n or 802.11ac. Multiplexer drivers 402 and 404 may then multiplex the received first communication (808), and provide the first communication to IP stacks 312 and 316 (810).

First network station 302 may then establish a second connection with second network station 304 according to a second network protocol (812). According to some embodiments, the second network protocol may correspond to a wireless standard, such as IEEE 802.11ad. First network station 302 and second network station 304 may then begin receiving a second communication according to the second network protocol enabled by second network devices 308 and 314 (814). The second communication may also be transmitted according to the second network protocol. Multiplexer drivers 402 and 404 may then multiplex the first and second communications (816). Consistent with some embodiments, multiplexing the first and second communications may include analyzing the first and second communications and determining if at least one capability is improved in one network protocol over the other network protocol. The analyzed capabilities include at least one of a speed, throughput, bandwidth, signal strength, and reliability of the first and second communications. Multiplexer drivers 402 and 404 may then determine if the second protocol provides at least one improved capability over the first protocol (818). If the second communication is determined to not have at least one improved capability provided by the second network protocol, multiplexer drivers 402 and 404 may continue to provide the first communication to IP stacks 312 and 316 (810). If the logic of multiplexer drivers 402 and 404 determine that the second communication according to the second network protocol provides at least one improved capability, multiplexer drivers 402 and 404 may provide the second communication to IP stacks 312 and 316 (820). Further, the second communication according to the second communications protocol may be provided to the IP stack without terminating the connection with the first communication. Similarly, the IP stack may then provide information back to the multiplexer driver, which may then be transmitted according to the second communications protocol by the network device that enables communication according to the second communications protocol.

Software, in accordance with the present disclosure, such as program code and/or data, may be stored on one or more machine readable mediums, including non-transitory machine readable medium. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

Consequently, embodiments as described herein may allow for a network station to switch from communicating over a first communications protocol to a second communications protocol without terminating any existing sessions on the first communications protocol. The examples provided above are exemplary only and are not intended to be limiting. One skilled in the art may readily devise other systems consistent with the disclosed embodiments which are intended to be within the scope of this disclosure. As such, the application is limited only by the following claims.

What is claimed is:

1. A method of switching a point-to-point network connection from a first network protocol to a second network protocol, comprising:
receiving a first communication according to the first network protocol;
establishing a connection to receive a second communication according to the second network protocol;
receiving the second communication; and
multiplexing the received first and second communications, wherein multiplexing the received first and second communications comprises:
analyzing the received first and second communications; and
selectively providing the received first and second communications to a protocol stack based on the analysis.

2. The method of claim 1, wherein:
receiving the first communication comprises enabling the first communication by a driver for the first network protocol; and
receiving the second communication comprises enabling the second communication by a driver for the second network protocol.

3. The method of claim 2, wherein the multiplexing comprises coupling a multiplexer driver between the protocol stack and the driver for the first network protocol and the driver for the second network protocol.

4. The method of claim 1, wherein the first network protocol comprises an IEEE 802.11n or 802.11ac wireless network protocol and the second network protocol comprises an IEEE 802.11ad network protocol.

5. The method of claim 1, wherein the protocol stack comprises an Internet Protocol (IP) stack.

6. The method of claim 1, wherein analyzing the received first and second communications comprises determining at least one of a throughput, a quality, or a capability of the first communication and the second communication.

7. The method of claim 1, wherein selectively providing the received first and second communications comprises selectively providing the communications without terminating an existing connection.

8. A method of transmitting and receiving communications according to at least a first network protocol and a second network protocol, comprising:
establishing a first connection to a network station to communicate according to the first network protocol;
coupling a multiplexer driver between an internet protocol (IP) stack and drivers enabling communications according to the first network protocol and the second network protocol;
receiving a first communication according to the first network protocol;
providing the received first communication to the IP stack;
establishing a second connection to the network station to communicate according to the second network protocol;
receiving a second communication according to the second network protocol;
multiplexing the received first and second communications; and
providing the received second communication to the IP stack if the second network protocol provides at least one capability that is an improvement over the first network protocol.

9. The method of claim 8, wherein the at least one improved capability comprises at least one of an improved throughput and an improved quality.

10. The method of claim 8, wherein multiplexing the received first and second communications comprises determining if the second network protocol provides at least one capability that is an improvement over the first network protocol.

11. The method of claim 8, further comprising continuing to provide the first communication to the IP stack if the second network protocol does not provide at least one capability that is an improvement over the first network protocol.

12. The method of claim 8, wherein the first network protocol comprises an IEEE 802.11n or 802.11ac wireless protocol and the second network protocol comprises an IEEE 802.11ad protocol.

13. A communications system, comprising:
a first network station capable of communications over at least a first network protocol and a second network protocol, the first network station comprising:
at least one processor;
a protocol stack for facilitating the communications;
a first network device for communicating according to the first network protocol;
a second network device for communicating according to the second network protocol; and
a multiplexer coupled between the first network device and the second network device and the protocol stack, wherein the multiplexer is configured to:
receive and transmit communications according to the first network protocol from and to the first network device;
receive and transmit communications according to the second network protocol from and to the second network device; and
receive and transmit communications according to a selected one of the first and second network protocols from and to the protocol stack.

14. The system of claim 13, wherein the selected one of the first and second network protocols is a network protocol with a highest throughput.

15. The system of claim 13, wherein the selected one of the first and second network protocols is a network protocol with a highest quality.

16. The system of claim 13, further comprising a second network station capable of communications over at least the first network protocol and the second network protocol, the second network station coupled to the first network station and in communication with the first network station according to at least one of the first network protocol and the second network protocol.

17. The system of claim 16, wherein the first network station and the second network station are in communication according to the selected one of the first and second network protocols.

18. The system of claim 13, wherein the multiplexer comprises a multiplexer driver enabled in the first network station when the first network station establishes communication with a second network station.

19. The system of claim 13, wherein the first network device comprises a driver enabling communications according to the first network protocol, and the second network device comprises a driver enabling communications according to the second network protocol.

20. The system of claim 13, wherein the first network station supports fast session transfer (FST).
